(19) United States
(12) Patent Application Publication
(10) Pub. No.: US 2026/0298075 A1
(43) Pub. Date: Oct. 1, 2026

(54) METHOD TO DETERMINE FRICTIONAL PRESSURE LOSSES FROM FLUID FLOW THROUGH WELLS, PERFORATIONS IN WELLS, AND IN THE NEAR-WELLBORE REGION FROM ANALYSIS OF WATER HAMMER

(71) Applicant: Seismos, Inc., Austin, TX (US)

(72) Inventors: Eric M. Dunham, Stanford, CA (US); Saeed Rahimi-Aghdam, Austin, TX (US); Junwei Zhang, Austin, TX (US); Nathan Crawford, Spring, TX (US)

(21) Appl. No.: 19/665,220

(22) Filed: May 1, 2026

Related U.S. Application Data
(63) Continuation of application No. PCT/US2024/054313, filed on Nov. 2, 2024.
(60) Provisional application No. 63/595,829, filed on Nov. 3, 2023.

(51) Int. Cl. E21B 47/06; G01V 20/00

(52) U.S. Cl. CPC E21B 47/06; G01V 20/00; E21B 2200/20

(57) ABSTRACT

A method for determining fluid friction pressure losses in a well into which fluid is being pumped includes measuring fluid pressure in the well while pumping at a first flow rate. The first rate is changed to a second rate and measuring the fluid pressure continues for a selected time. A pressure response of the well using a selected value of a parameter related to pipe friction factor f is modeled. The modeled pressure response is compared to the measured pressure. A value of the parameter related to f is adjusted and the modeling and comparing are repeated until the modeled pressure response substantially matches the measured pressure. The first flow rate is chanted and the measuring, modeling, comparing, adjusting the parameter related to f and repeating modeling and comparing are repeated to determine a relationship between the value of the parameter related to f and the first flow rate.

### CROSS REFERENCE TO RELATED APPLICATIONS

Continuation of International Application No. PCT/US2024/054313 filed on Nov. 2, 2024. Priority is claimed from U.S. Provisional Application No. 63/595,829 filed in Nov. 3, 2023. Both the foregoing applications are incorporated herein by reference in their entireties.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of pumping fluid into subsurface wells for treatment of the well and reservoir formation(s) hydraulically connected to the well. More specifically, the disclosure relates to methods for determining amounts of fluid pressure loss during pumping such treatments in order to characterize the effect of pumping such treatments on the well and on the hydraulically connected reservoir formation(s).

Fluids are injected through wells into subsurface earthen formations for purposes that include hydraulic fracturing and other well stimulation processes. Hydraulic fracturing is performed to enhance reservoir formation permeability (increasing the effective radius of the wellbore within the reservoir formation), thereby facilitating extraction of oil and gas, or to create flow paths used for heat exchange in geothermal energy production. The creation of hydraulic fractures by fluid injection is a subset of well stimulation. During multistage hydraulic fracturing, wherein a plurality of different zones in a reservoir formation are to be fractured, the portion of the well passing through the reservoir formation may be divided into shorter axial segments referred to as “stages.” During stimulation, the currently treated stage is isolated from any and all lower (deeper) stages by, e.g., setting a plug in the wellbore. The wellbore may then be perforated, i.e., openings created in the well pipe or casing, in a set of perforation clusters, and fluids are injected into the well and then through the perforations to create hydraulic fractures in the formation.

The effectiveness of hydraulic fracturing depends to a great extent on controlling the fluid pressure in the well, especially around the perforations, and in the subsurface formation around and some lateral distance away from the well, the so-called “near wellbore region.” However, it is difficult, expensive, and in some cases impossible to measure pressure within and outside the well. Contributing to the challenge of determining formation and in-well fluid pressure using pressure measurements made in convenient places along the well (e.g., near the wellhead at surface) is the fact that fluid flow through the well, the perforations, and the near-wellbore region is accompanied by energy dissipation and pressure losses from viscous drag and turbulence.

The fluid pressure within hydraulic fractures in a reservoir formation, p_{f}, is related to wellhead pressure, p_{wh}, by the expression (see, e.g., Economides et al., 2002; Cramer et al., 2019; Mondal et al., 2021):

$${p}_{w h} = {p}_{f} - {p}_{hyd} + {p}_{pipe} + {p}_{perf} + {p}_{nwb} , \qquad ( 1 )$$

where p_{hyd} is the hydrostatic pressure of the column of fluid within the well, pₚᵢₚₑ is the frictional pressure loss from flow within the well (pipe friction, typically quantified in terms of pressure loss per unit distance along the pipe, dpₚᵢₚₑ/dx), p_{perf} is the frictional pressure loss from flow through the perforations (perforation friction), and p_{nwb} is the frictional pressure loss from flow through tortuosity in the near-wellbore region (near-wellbore friction). These pressure losses are functions of the volumetric flow rate Q:

$$\frac{d {p}_{pipe}}{d x} = \frac{8 f ρ}{{π}^{2} {D}^{5}} {Q}^{2} , \qquad ( 2 )$$

where x is measured depth along the well, f is the Darcy-Weisbach friction factor (e.g., Moody, 1944; Chen, 1979), p is the fluid density, D is the inner diameter of the well;

$${p}_{perf} = {k}_{perf} {Q}^{2} , \qquad ( 3 )$$

where k_{perf} is the perforation friction factor (e.g., Cramer, 1987; Crump & Conway, 1988); and

$$PNWB = {k}_{NWB} {Q}^{ξ} , \qquad ( 4 )$$

where k_{NWB} is the near-wellbore friction factor and & is the near-wellbore exponent that is typically between 0.25 and 1 (see, e.g., Cramer et al., 2019; Mondal et al., 2021).

There are several known methods to determine these frictional pressure losses. Pipe friction is most commonly determined by empirical or theoretical models that are calibrated by flow loop experimental data (see, e.g., Lord & McGowen, 1986; Keck et al., 2002; Yang et al., 2018). The theoretical models are based on the recognition that the Darcy-Weisbach pipe friction factor f depends on the Reynolds number (see, e.g., Moody, 1944; Chen, 1979), of the fluid being injected and the pipe in which the fluid flows. The Reynolds number is proportional to injection rate Q and inversely proportional to fluid viscosity. The pipe friction factor also depends on the roughness of the pipe surface. In many hydraulic fracturing treatments, chemicals known as friction reducers are added to water or brine to suppress turbulence and reduce pipe friction. The reduction in pipe friction is influenced by the chemical composition of the friction reducer and its concentration (see, e.g., Virk, 1975; Lord & McGowen, 1986; Keck et al., 2002; Yang et al., 2018). In situations where produced water or brine from a subsurface formation is used as or in the injected fluid, pipe friction is also affected by the composition of the water or brine, for example, as measured by total dissolved solid concentration, which can interact with the friction reducer chemicals (see, e.g., Yang et al., 2018). All of these factors lead to considerable uncertainty in pipe friction (see, e.g., Cramer et al., 2019).

The uncertainty in pipe friction using the above methods can be reduced by measuring pipe friction for the specific well of interest and for the particular fluid being used. Pipe friction measurement can be performed by placing two or more pressure sensors in the well at different depths, e.g., one in the wellhead and another at a selected depth below surface, determining differences in the measured pressures at different fluid flow rate conditions, and accounting for hydrostatic pressure differences between the sensors. The foregoing method is not widely used because of the difficulty associated with deploying sensors within the well, especially at the reservoir depth.

Perforation and near-wellbore friction are commonly measured using step-down tests. In a step-down test, the fluid injection rate is decreased through a sequence of steps and held constant at each flow rate until the wellhead pressure stabilizes. The stabilized wellhead pressure is measured for the different injection rates. The differences in wellhead pressure at the different flow rates are attributed to differences in pipe, perforation, and near-wellbore friction. After correcting for pipe friction, typically by using an empirical model as explained previously, a regression is performed on the pressure measurements to determine perforation and near-wellbore friction (see, e.g., Cramer et al., 2019; Mondal et al., 2021). It is possible to uniquely separate perforation and near-wellbore friction, if the measurements span a wide range of rates, because they have different dependence on rate. One challenge in the application of this method is that any errors in pipe friction, which is proportional to Q², cause errors in perforation friction, which is also proportional to Q².

All of the foregoing considerations make it desirable to have a method that is inexpensive and noninvasive (meaning that it requires no sensors to be placed below the surface in the well, only at the wellhead) and which is capable of uniquely determining pipe friction, perforation friction, and near-wellbore friction.

### SUMMARY

One aspect of the present disclosure is a method for determining fluid friction pressure losses in a well into which fluid is being pumped. A method according to this aspect includes measuring fluid pressure in the well while pumping at a first flow rate. The first rate is changed to a second rate and measuring the fluid pressure continues for a selected time. A pressure response of the well using a selected value of a parameter related to pipe friction factor f is modeled. The modeled pressure response is compared to the measured pressure. A value of the parameter related to f is adjusted and the modeling and comparing are repeated until the modeled pressure response substantially matches the measured pressure. The first flow rate is changed and the measuring, modeling, comparing, adjusting the parameter related to f and repeating modeling and comparing are repeated to determine a relationship between the value of the parameter related to f and the first flow rate.

Some implementations further comprise continuing measuring pressure until a reflected tube wave event is detected. A pressure response of the well is modeled using a selected value of the hydraulic impedance of the stage Zₛ, or a similar parameter describing the reflection such as the reflection coefficient R, for at least the first flow rate. The value of Zₛ is adjusted and the modeling the pressure response for the first flow rate and the second flow rate is repeated until the modeled pressure response substantially matches the measured pressure. The first flow rate is changed and the foregoing actions are repeated to determine a relationship between the first flow rate and Zₛ, and the relationship between Zₛ and the first flow rate are used estimate values of frictional pressure loss through well perforations and frictional pressure loss in a near wellbore region.

Some implementations further comprise determining a design friction pressure loss for the well perforations and using the estimated frictional pressure loss through the well perforations to obtain a value of perforation cluster efficiency.

Some implementations further comprise changing at least one composition parameter of the fluid being pumped into the well, and the modeling is repeated to determine a relationship between the at least one composition parameter and the relationship between f and the first flow rate.

Some implementations further comprise using the relationship between the at least one composition parameter and the relationship between the parameter related to f and the first flow rate to determine an optimum value of the at least one composition parameter.

Some implementations further comprise using the relationship between the value of the parameter related to f and the first flow rate to determine an optimum value of the first flow rate.

A method for determining fluid friction pressure losses in a well into which fluid is being pumped according to another aspect of the present disclosure includes measuring fluid pressure in the well while pumping the fluid at a first flow rate. The first flow rate is changed to a second flow rate different than the first flow rate and measuring the fluid pressure continues after the changing for a selected time. A pressure response of the well is modeled using a selected value of a parameter related to pipe friction factor f. The modeled pressure response is compared to the measured pressure. A value of the parameter related to f is changed and the modeling and comparing are repeated until the modeled pressure response substantially matches the measured pressure. At least one composition parameter of the fluid being pumped is changed and the foregoing are repeated, and a relationship between the value of the parameter related to f and the at least one composition parameter is determined.

Some implementations further comprise using the relationship to determine an optimum value of the at least one composition parameter.

Some implementations further comprise, continuing measuring pressure until a reflected tube wave event is detected. A pressure response of the well is modeled using a selected value of the hydraulic impedance of the stage Zₛ, or a similar parameter describing the reflection such as the reflection coefficient R, for at least the first flow rate. The value of Zₛ is adjusted and the modeling the pressure response for the first flow rate and the second flow rate is repeated until the modeled pressure response substantially matches the measured pressure. The first flow rate is changed and the foregoing actions are repeated to determine a relationship between the first flow rate and Zₛ, and the relationship between Zₛ and the first flow rate are used estimate values of frictional pressure loss through well perforations and frictional pressure loss in a near wellbore region.

Some implementations further comprise determining a design friction pressure loss for the well perforations and using the estimated frictional pressure loss through the well perforations to obtain a value of perforation cluster efficiency.

A method for determining fluid friction pressure losses in a well into which fluid is being pumped according to another aspect of the present disclosure includes measuring fluid pressure in the well while pumping the fluid at a first flow rate. The first flow rate is changed to a second flow rate different than the first flow rate and the measuring the fluid pressure after the changing from the first flow rate to the second flow rate continues at least until a first reflected tube wave event is detected in the measured pressure. The second flow rate is chanted to a third flow rate different from the first flow rate and the second flow rate and the measuring the fluid pressure after the changing from the second flow rate to the third flow rate continues until a second reflected tube wave event is detected in the measured pressure. Fluid pressure in the well is modeled using selected initial values for frictional pressure loss in the well, frictional pressure loss in well pipe perforations and frictional pressure loss in a near wellbore zone in a reservoir formation. The modeled pressure is compared to the measured pressure. The initial values of the frictional pressure loss in the well, frictional pressure loss in well pipe perforations and frictional pressure loss in the near wellbore zone are adjusted and the modeling the fluid pressure in the well is repeated until the modeled fluid pressure in the well matches the measured pressure in the well for all of the first flow rate, the second flow rate and the third flow rate.

Some implementations further comprise determining a design friction pressure loss for the well perforations and using the estimated frictional pressure loss through the well perforations to obtain a value of perforation cluster efficiency.

Some implementations further comprise changing at least one composition parameter of the fluid, and repeating the modeling and comparing to determine a relationship between the at least once composition parameter and the frictional pressure loss in the well, frictional pressure loss in well pipe perforations and frictional pressure loss in the near wellbore zone.

Other aspects of the present disclosure include a non-transitory computer readable medium having stored thereon logic operable to cause a programmable computer to perform acts comprising the actions carried out on the various measurements of fluid pressure in the well made as described with reference to the various methods disclosed herein.

Other aspects and possible advantages will be apparent from the description and claims that follow.

### BRIEF DESCRIPTION OF THE DRAWINGS

FIG. 1 shows an example implementation of generating and acquiring signals that may be used in accordance with the present disclosure.

FIG. 2 shows a representative water hammer measurement at the wellhead using a high sample rate pressure sensor.

FIGS. 3A and 3B show an enlarged view of the water hammer from the fourth fluid injection rate drop shown in FIG. 2. FIG. 3B shows the measured pressure at the wellhead, and FIG. 3A shows the injection rate inferred to have caused the water hammer.

FIG. 4 and FIG. 5 show graphically an example of regressions for friction factor and pressure loss per unit distance, respectively, as a function of flow rate Q.

FIGS. 6A and 6B shows graphs of two water hammer sequences generated by multiple, consecutive rate drops during shut in.

FIGS. 7A and 7B show an enlarged view of water hammer reflection from the stage, for the example shown in FIG. 6A. FIGS. 7C and 7D show an enlarged view of water hammer reflection from the stage, for the example shown in FIG. 6B. FIGS. 7B and 7D show the measured pressure at the wellhead, and FIGS. 7A and 7C show the injection rate inferred to have caused the water hammers.

FIG. 8A shows in pressure losses from perforation and near-wellbore friction as a function of flow rate. FIG. 8B shows reflection coefficient for a tube wave carrying a rate drop ΔQ=10 bbl/min as a function of initial flow rate. FIG. 8C shows the error in reflection coefficient from neglecting the near-wellbore friction.

FIG. 9 shows a graph of wellhead pressure during stimulation of one fracture treatment stage.

FIGS. 10A through 10D show an enlarged view of the water hammers from two rate drops during stimulation, as marked in FIG. 9. FIGS. 10B and 10D show the measured pressure at the wellhead, and FIGS. 10A and 10C show the injection rate inferred to have caused the water hammers.

FIGS. 11A through 11H show graphs of four water hammers from the same stage but starting at different initial rates Qᵢ. FIGS. 11B, 11D, 11F, and 11G show the measured pressure at the wellhead, and FIGS. 11A, 11C, 11E, and 11H show the injection rate inferred to have caused the water hammers.

FIGS. 12A and 12B show an example of a rate drop that is too slow for unique determination of pipe friction and perforation friction but for which a modified acoustic friction analysis using a calibrated pipe friction model can be used to determine perforation friction and near-wellbore friction. FIG. 12B shows the measured pressure at the wellhead, and FIG. 12A shows the injection rate inferred to have caused the water hammers.

FIG. 13 shows an example computing system that may implement various methods according to the present disclosure.

### DETAILED DESCRIPTION

The present disclosure provides a method, termed “acoustic friction analysis,” to determine frictional pressure losses caused by the well pipe, by the perforations in the pipe and by the near wellbore formation using water hammer (tube wave) analysis. In general, methods according to the present disclosure may be performed in connection with pumping fluid into a well and measuring fluid pressure in the well. Fluid pumping may be performed, e.g., in connection with hydraulic fracture treatment of a well in one or more zones or stages of a reservoir formation in fluid communication with the well. Fluid is pumped (injected) into a well at a rate that may be determined by direct measurement, such as by a flowmeter, or by inference from indirect measurements such a fluid pump operating rate. Such flow rates are those referred to below in the description of how to implement a method according to the present disclosure. Pressure may be measured proximate the upper end of the well, e.g., in the wellhead, using a rapid response sensor such as a quartz pressure transducer. Such measurements may be digitally sampled for processing as described herein; for such purposes, the digital sample rate of the pressure measurements may be 10 Hz or greater, although the sample rate, the type of sensor or its location are not limitations on the scope of the present disclosure.

A. Signal Acquisition Used with Methods According to the Disclosure

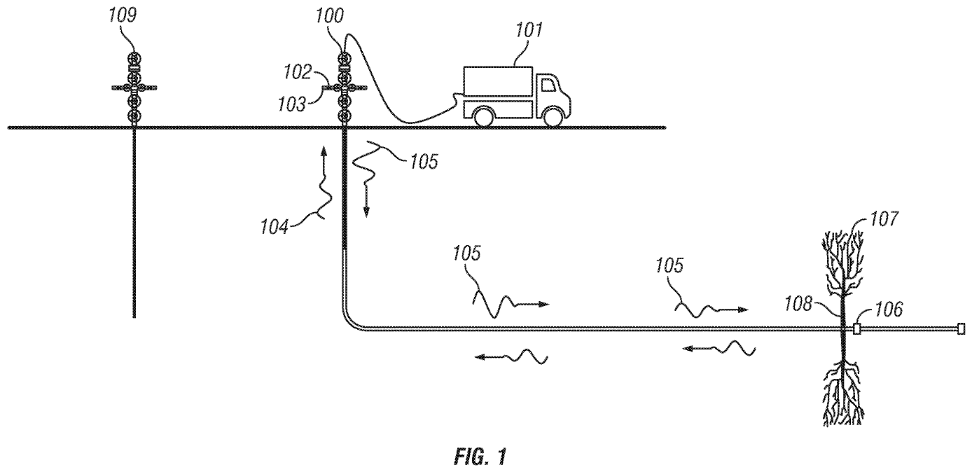

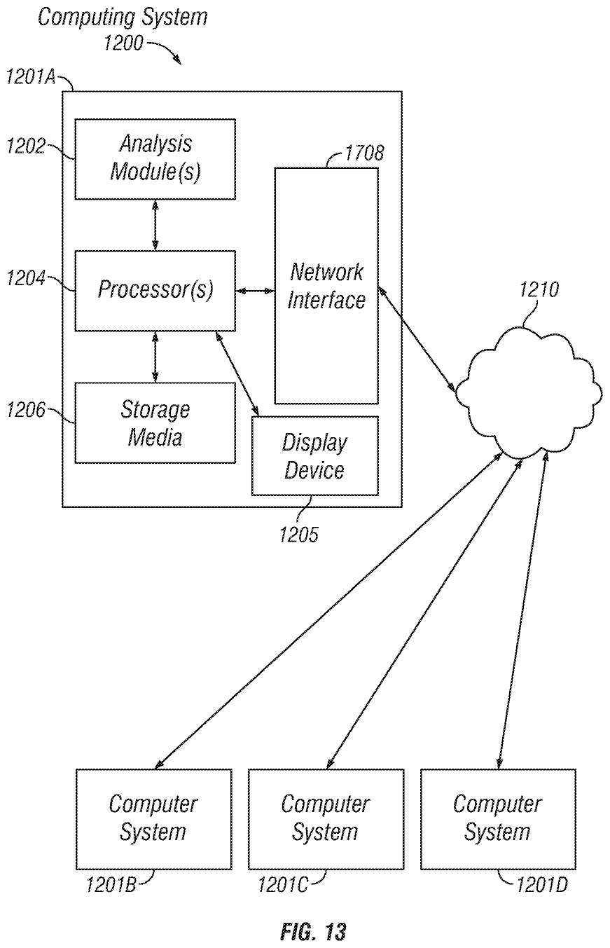

FIG. 1 is a schematic diagram of an example well data acquisition system (“system”) that may be used in some implementations. The system 100 comprises components associated with a well including one or more fluid pump 101, such as hydraulic fracturing fluid pumps or other fluid treatment pumps; sensors such as hydrophones or pressure transducers 102 in fluid pressure communication with the well; a data acquisition and processing apparatus 103 (described in more detail below with reference to FIG. 13); a well pipe 104, e.g., a casing or liner disposed in a well drilled through a reservoir formation; a plug or wellbore bottom 106; a formation fracture network 107 in hydraulic communication with the well through perforations 108 made in the well pipe (e.g., casing or liner) 104. A nearby well 109 may be present in the area of interest. One or more water hammer pulses 105 may be generated by the pumps 101, such as by a step change in the rate of pumping. The water hammer pulse(s) 105 travel along the well in the form of tube waves. The sensors 102 may be, for example and without limitation, nonintrusive devices such as pressure transducers, accelerometers, and hydrophone(s), or optical fiber, any or all of which may be disposed in a location on or near the top of the well (e.g., the wellhead) to measure pressure, pressure time derivative and/or particle motion of fluid in the well continuously before, during, and after pumping of a treatment such as an hydraulic fracture treatment. Characteristics of such data may be analyzed as explained below to obtain parameters such as frictional pressure loss along the well and through the perforations also as will be explained in more detail below.

A computer or computing system, which will be further explained with reference to FIG. 13, may implement various example processes on measurements of pressure made as described herein to obtain values related to friction and pressure loss due to friction in various parts of a well and surrounding reservoir formation.

### B. Acoustic Friction Analysis

Dunham et al. (2023) sets forth a method for determining well pipe and perforation friction using wellhead pressure measurements during water hammer created by abrupt changes in fluid injection rate into the well, e.g., during fracture treatment. Water hammer comprises tube waves, a type of pressure wave that propagates at a speed, c, which speed depends on the fluid density ρ, the fluid compressibility, and the compliance of the well. Tube wave propagation in the well is governed by the expression (see, Wylie et al., 1993):

$$\frac{ρ}{A} \frac{\partial Q}{\partial t} + \frac{\partial p}{\partial x} = - \frac{8 f ρ}{{π}^{2} {D}^{5}} {Q}^{2} , \qquad ( 5 )$$

$$\frac{A}{ρ {c}^{2}} \frac{\partial p}{\partial t} + \frac{\partial Q}{\partial x} = 0 , \qquad ( 6 )$$

where t is time, Q(x, t) is volumetric flow rate, and p(x, t) is the pressure in the well at well depth x less the hydrostatic pressure. Initial conditions for Q(x, 0) and p(x, 0) as well as two boundary conditions, one at the wellhead (x=0) and a second at the depth (axial position along the well) of the fracture treatment stage under investigation (x=L), are also required. The initial conditions correspond to steady flow at a constant injection rate:

$$Q ( x , 0 ) = {Q}_{0} , \qquad ( 7 )$$

$$p ( x , 0 ) = {p}_{0} - \frac{8 f ρ {Q}_{0}^{2}}{{π}^{2} {D}^{5}} x , \qquad ( 8 )$$

where p₀ is the pressure at the wellhead prior to a change in the flow rate that generates water hammer. f represents a pipe friction factor. At the wellhead, the fluid injection rate is specified as a boundary condition. At time t=0, the injection rate is rapidly changed, in this example, decreased, by an amount ΔQ, such that:

$$Q ( 0 , t ) = {Q}_{0} - Δ QH ( t ) , \qquad ( 9 )$$

where H(t) is the unit step function.

The method described herein does not require a step function (instantaneous) flow rate change (drop), but the flow rate change does need to be sufficiently rapid to isolate certain waveform features used in the analysis. The boundary condition at the stage is represented by the following expression:

$$p ( L , t ) = {P}_{f} - {p}_{hyd} + {p}_{s} ( Q ) , \qquad ( 10 )$$

where the total pressure loss from perforation and near-wellbore friction of the particular treatment stage is defined by the expression:

$${p}_{s} ( Q ) = {p}_{pref} ( Q ) + {p}_{NWB} ( Q ) . \qquad ( 11 )$$

Hydrostatic pressure p_{hyd} has been subtracted from the fracture pressure p_{f} because p(x, t) is defined as the pressure adjusted to remove hydrostatic pressure.

Tube waves may be generated in the well, for example, by such rapid (“step”) changes in the fluid flow rate, which changes may induce what is referred to as water hammer; the resulting tube waves propagate along the well and interact with the perforations, the near-wellbore region, and any hydraulic fractures in the formation in a manner that ultimately may induce reflected tube waves that propagate back up the well to the wellhead.

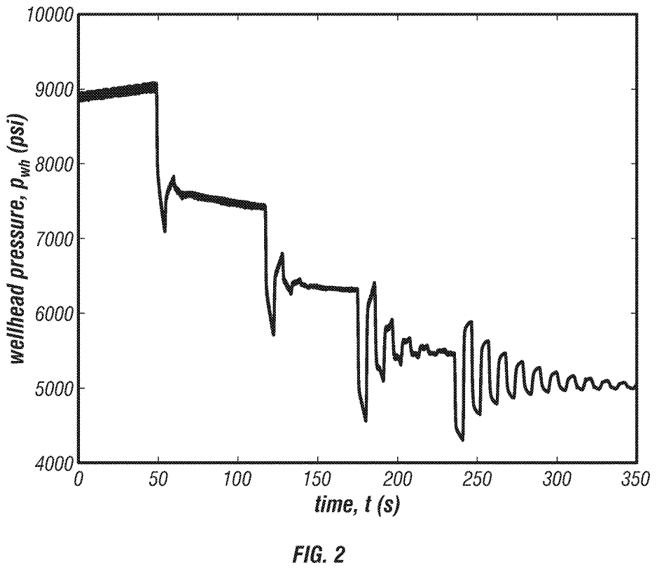

FIG. 2 shows a graph of fluid pressure in a well undergoing fluid injection, e.g., during pumping hydraulic fracture treatment, wherein changes in fluid injection (flow) rate are made at selected times. The pressure response to the flow rate changes exhibits representative water hammer obtained from pressure measurements made, e.g., proximate the wellhead using a rapid response (high frequency response capable) pressure sensor. The pressure measurements should be sampled at high enough rate to properly sample the waveform features used in the present analysis and to avoid aliasing (see, e.g., Wang et al., 2008; Dung et al., 2021).

Representative water hammer oscillations created by four consecutive drops in fluid injection rate during the shut-in process at the end of a hydraulic fracture stimulation treatment are shown in the graph in FIG. 2. While the drops in flow rate are comparable in size, the water hammers differ in the oscillation amplitude and the number of oscillations. These differences are caused by a nonlinear dependence on the initial fluid injection (flow) rate prior to the rate change of flow rate. Each of the four water hammers shown in FIG. 1 was created by a rapid decrease in injection flow rate from Q₀ to Q₀−ΔQ. The water hammers each have comparable ΔQ but different values of Q₀, which represents the injection rate prior to the injection rate change. Parts of the following description are explained in terms of a fluid injection rate drop; it should be clearly understood that in principle a method according to the present disclosure may be performed using injection rate increases provided that the injection rate change is sufficiently abrupt to induce tube waves in the well.

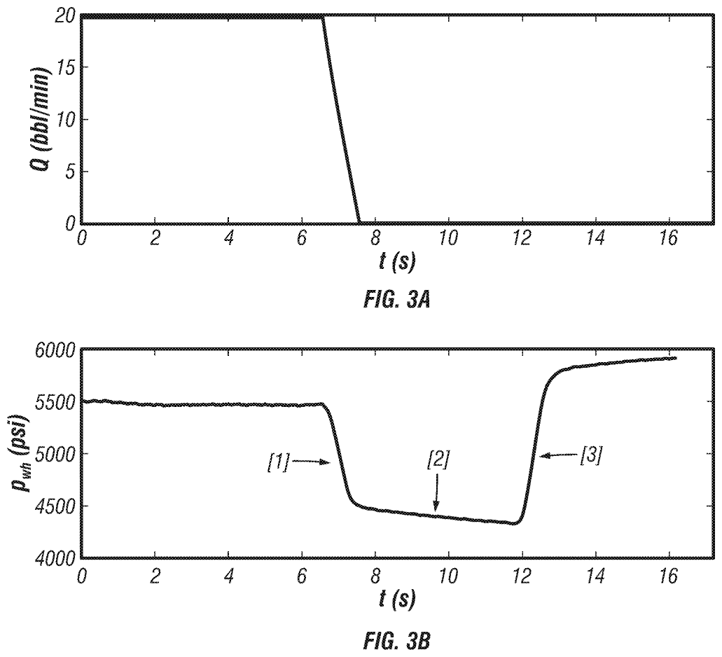

FIGS. 3A and 3B show an enlarged view of the water hammer from the fourth fluid injection rate drop shown in FIG. 2. FIG. 3B shows an enlarged view of the water hammer resulting from the fourth injection rate drop shown in FIG. 2. Key features used in the following acoustic friction analysis are marked. The features labeled [1], [2], and [3] in FIG. 3B are the pressure drop that accompanies the rate drop, further depressurization caused by pipe friction, and the reflection from the particular fracture treatment stage in progress, respectively.

As can be observed in FIG. 3A and FIG. 3B, drop in injection rate is accompanied by a drop in pressure (feature [1] in FIG. 3B) that is proportional to the injection rate drop, Δp=Z_{T}ΔQ, where Z_{T}, determinable by the expression:

$${Z}_{T} = \frac{ρ c}{A} \qquad ( 12 )$$

represents the tube wave hydraulic impedance, with A=πD²/4 being the cross-sectional area of the well, e.g., the well casing or liner. As the tube wave propagates along the well, it is attenuated by pipe friction. This attenuation is expressed in the wellhead pressure as an additional reduction in pressure (feature [2] in FIG. 3B) after the initial pressure drop that accompanies the injection rate drop. Measurement of the slope of the depressurization “ramp” can provide a measurement of pipe friction (see, Dunham et al., 2023). Analysis of the reflection (feature [3] in FIG. 3B) can provide constraints on perforation and near-wellbore friction, as explained below.

### C. Calibrated Model for Pipe Friction

Pipe friction measurements can be performed using acoustic friction analysis for water hammers that sample different fluid injection rates. The analysis can be done for multiple water hammers within a fracture treatment stage and/or across multiple stages within a well. The foregoing provides pipe friction values, quantified, e.g., as pressure loss per unit distance, dpₚᵢₚₑ/dx, or a friction factor, f, or related parameter, for different fluid injection (flow) rates Q. A regression can be performed on these data to provide a mathematical model for pipe friction or pressure loss as a function of flow rate (see, e.g., Virk, 1975). The regression can also include data spanning a range of fluid compositions or friction reducer concentrations, with parameters quantifying these included in the model.

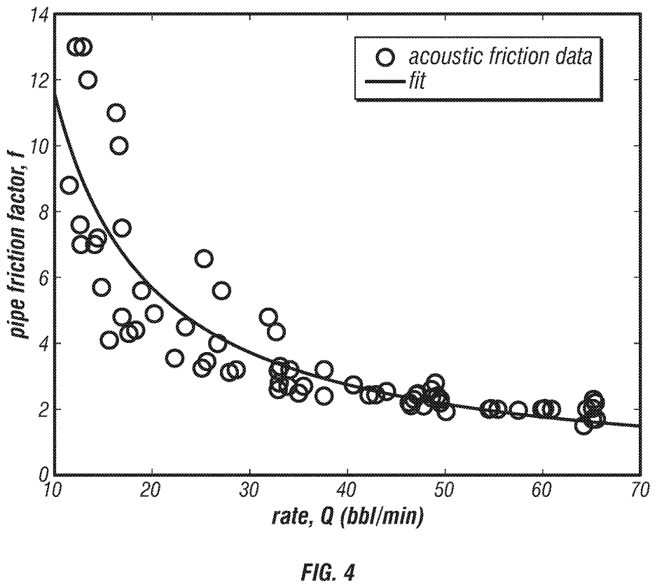

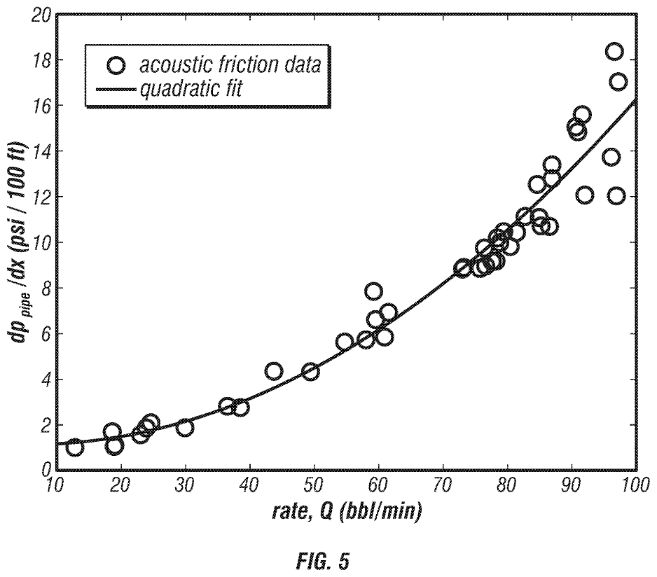

FIGS. 4 and 5 show graphically an example of regressions for friction factor and pressure loss per unit distance, respectively, as a function of injection rate Q. FIG. 4 shows a compilation from acoustic friction measurements of the Darcy-Weisbach pipe friction factor f performed at different flow rates (indicated by circles). The curve in FIG. 4 is the best-fitting model (deterministic expression) in the form f=f₀(1+a/Q), where model parameters f₀ and a may be determined by nonlinear least squares regression.

FIG. 5 shows a compilation from acoustic friction calculation of the pipe friction pressure loss per unit distance, dpₚᵢₚₑ/dx in units of psi/ft, performed at different injection rates in units of bbl/min (indicated by circles). The curve in FIG. 5 is the best-fitting quadratic polynomial obtained by linear least squares regression: dpₚᵢₚₑ/dx=0.0012-0.0183Q+1.1823Q².

### Tube Wave Reflection

Next consider reflection of tube waves from the fracture treatment stage (feature [3] in FIG. 3). The reflection coefficient R is defined as the ratio of the amplitude of the pressure change carried by the reflected tube wave to that of the incident wave. For sufficiently small amplitude tube waves, reflection from the stage is controlled by the ratio of the tube wave hydraulic impedance to the hydraulic impedance of the fracture treatment stage, Zₛ. The reflection coefficient in this case is given by the expression (see, e.g., Paillet & White, 1982):

$$R = \frac{{Z}_{s} - {Z}_{T}}{{Z}_{s} + {Z}_{T}} . \qquad ( 13 )$$

The hydraulic impedance of the treatment stage has contributions from perforation friction and near-wellbore friction. These components of the system are hydraulically in series, such that

$${Z}_{s} = {Z}_{perf} + {Z}_{NWB} , \qquad ( 14 )$$

where Z_{perf} is the hydraulic impedance of the perforations and Z_{NWB} is the hydraulic impedance of the near-wellbore region. Hydraulic impedance is defined as the ratio of pressure change to flow rate change, or dp/dQ for sufficiently small changes in flow rate. Thus, from equations (3) and (4) in the Background section herein:

$${Z}_{perf} = 2 {k}_{perf} Q \qquad ( 15 )$$

$$and$$

$${Z}_{NWB} = ζ {k}_{NWB} {Q}^{ξ - 1} . \qquad ( 16 )$$

The reflection coefficient can also be calculated for tube waves of arbitrary amplitude. This is done by solving the tube wave equations (5) and (6) in the vicinity of the fracture treatment stage where the reflection occurs. The pressure and flow rate within the well, in the vicinity of the relevant treatment stage, are obtained using the method of characteristics as by the following expressions:

$$p ( x , t ) = {p}_{0} - \frac{8 f ρ {Q}_{0}^{2}}{{π}^{2} {D}^{S}} x - {Z}_{T} Δ QH ( t - \frac{x - L}{c} ) - R {Z}_{T} Δ QH ( t + \frac{x - L}{c} ) , \qquad ( 17 )$$

$$Q ( x , t ) = {Q}_{0} - Δ QH ( t - \frac{x - L}{c} ) + R Δ QH ( t + \frac{x - L}{c} ) . \qquad ( 18 )$$

The next-to-last term in equations (17) and (18) is the incident wave and the last term is the reflected wave, having relative amplitude R. Attenuation of tube waves by pipe friction has been neglected in these expressions for the incident and reflected wave, as it is unnecessary for calculating the reflection coefficient because the reflection depends only on processes occurring in the vicinity of the stage. However, if the measured depth to the stage is sufficiently long that the tube wave amplitude has decreased appreciably from its amplitude near the wellhead, then the drop in flow rate carried by the tube wave, denoted by ΔQ in the expressions above, might be smaller than the rate drop at the wellhead. The expressions for reflection coefficient that are provided below should be evaluated using the attenuated rate drop, though only a small error will be incurred by using the wellhead rate drop. At the location of the fracture treatment stage (x=L), the pressure and flow rate are given by the expressions:

$$p ( L , t ) = {p}_{0} - \frac{8 f ρ {Q}_{0}^{2}}{{π}^{2} {D}^{5}} L - ( 1 + R ) {Z}_{T} Δ Q H ( t ) , \qquad ( 19 )$$

$$Q ( L , t ) = {Q}_{0} - ( 1 - R ) Δ Q H ( t ) . \qquad ( 20 )$$

The reflection coefficient R may be obtained by solving the following nonlinear equation:

$${p}_{s} ( {Q}_{0} ) - {p}_{s} ( {Q}_{0} - ( 1 - R ) Δ Q ) = ( 1 + R ) {Z}_{T} Δ Q . \qquad ( 21 )$$

The expression for pressure drop on the left side is obtained by evaluating the pressure at the stage, given by equation (10), first with the initial rate and then with the rate upon reflection given by the last term in equation (20), and then determining differences in the pressures. It is assumed that differences in the hydrostatic pressure, p_{hyd}, and the fracture pressure, p_{f}, are small in comparison to the changes in frictional pressure, pₛ(Q). The pressure drop on the right side is from the last term in equation (19). Equation (21) can be solving using any scalar root-finding method like bisection, secant, or Newton-Raphson. When ΔQ is sufficiently small, the left side of eq. (21) can be approximated using a Taylor series expansion in rate about the initial rate, yielding the expression:

$$( 1 - R ) {Z}_{s} ( {Q}_{0} ) = ( 1 + R ) {Z}_{T} , \qquad ( 22 )$$

where Zₛ(Q)=dpₛ/dQ. It follows that:

$$R = \frac{{Z}_{s} - {Z}_{T}}{{Z}_{s} + {Z}_{T}} , \qquad ( 23 )$$

as stated in equation (13).

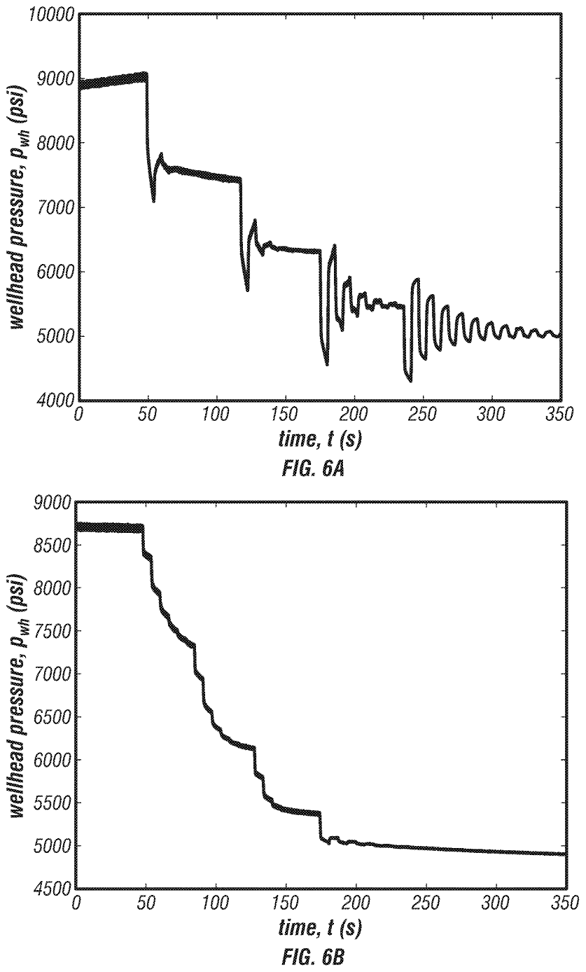

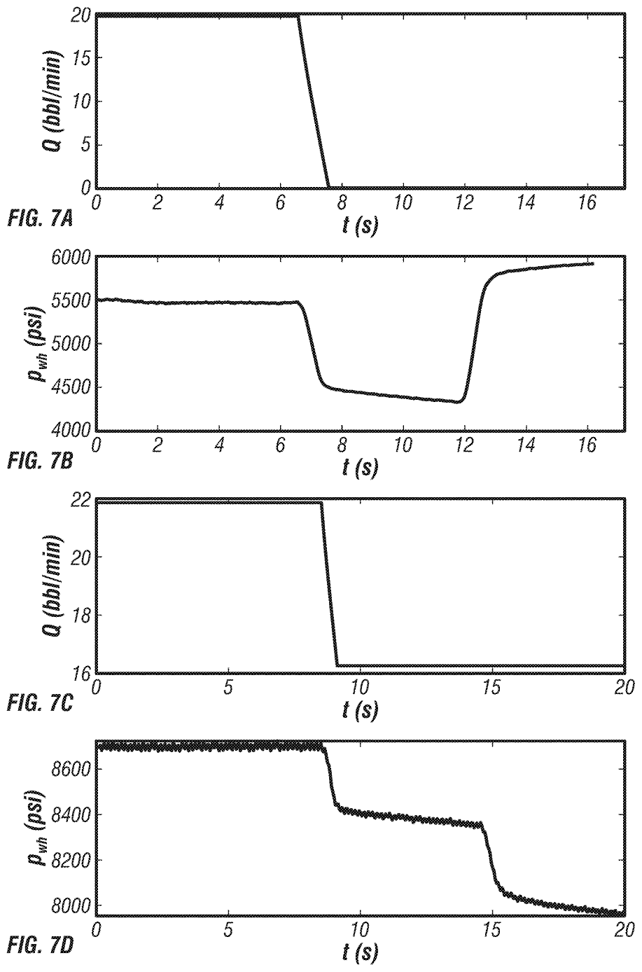

FIGS. 6A and 6B provide a comparison of two examples with different perforation cluster designs, both from the same well in the Bakken formation, North Dakota. The example shown in FIG. 6A has 14 clusters and 28 perforation holes and the example shown in FIG. 6B has only 1 cluster and 3 perforation holes. The perforation hole diameters are all the same. The perforation friction coefficient k_{perf} is inversely proportional to the square of the number of perforation holes, so k_{perf} and hence Z_{perf} are expected to be 87 times higher for the one cluster design. This difference in perforation friction is evident in the zoomed in view of the water hammer reflections shown in FIGS. 7B and 7D. For the 14 cluster design, illustrated in FIGS. 6A, 7A, and 7B, the reflection coefficient is negative (R<0), indicating that the hydraulic impedance of the stage is less than the tube wave hydraulic impedance (Zₛ<Z_{T}). For the 1 cluster design, illustrated in FIGS. 6B, 7C, and 7D, the reflection coefficient is positive (R>0), indicating that the hydraulic impedance of the stage is greater than the tube wave hydraulic impedance (Zₛ>Z_{T}). This is consistent with the increased perforation impedance and hence perforation friction for the 1 cluster design.

FIGS. 7A through 7D show an enlarged view of water hammer reflection from each stage, for the two examples shown in FIGS. 6A and 6B. The reflection from the stage with 14 clusters and 28 perforations has a negative reflection coefficient, caused by low k_{perf}, which is shown in FIG. 7B. FIG. 7D shows the reflection from the stage with 1 cluster and 3 perforations has a positive reflection coefficient, caused by high k_{perf} FIGS. 7A and 7C show the change in injection rate that created the water hammer.

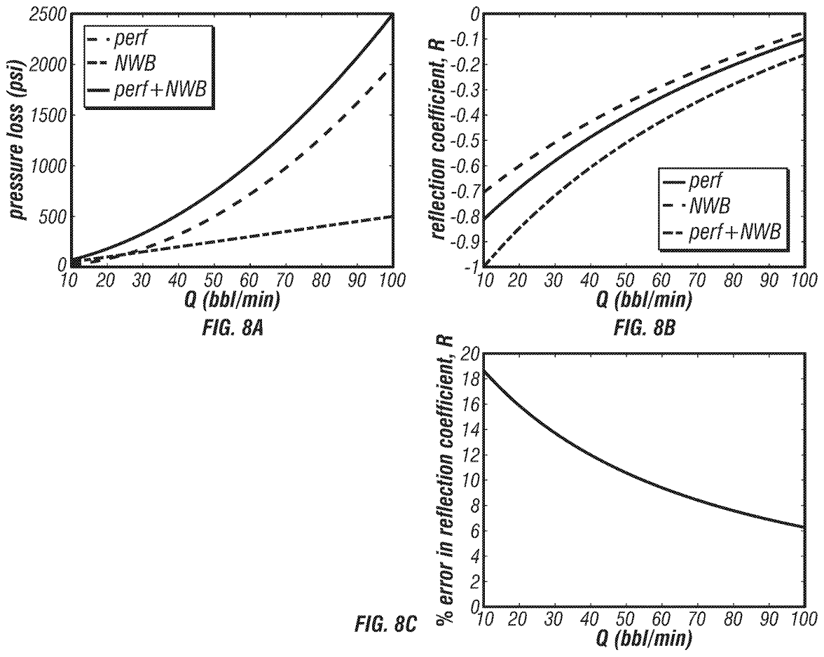

The relative contributions of perforations and the near-wellbore region in the reflection process can be quantified as a function of flow rate using the expressions provided above. FIGS. 8A through 8C show an example with parameters (listed in Table 1) that are representative of limited entry hydraulic fracture designs. The parameters give frictional pressure losses from perforations and the near-wellbore region of 2000 psi and 500 psi, respectively, at an injection rate of 100 bbl/min, which is typical for stimulation.

TABLE 1
Representative parameters for calculation
of reflection coefficient in FIG. 7

| | | |
|---|---|---|
| Fluid density ρ | 8.35 | lb/gal |
| Tube wave speed c_{T} | 4921.26 | ft/s |
| Inner diameter of well D | 4.67 | in |
| Perforation friction coefficient k_{perf} | 0.2 | psi/(bbl/min)² |
| Near-wellbore friction coefficient k_{NWB} | 5 | psi/(bbl/min) |

| | |
|---|---|
| Near-wellbore exponent ξ | 1 |

FIG. 8A shows the pressure losses from perforation and near-wellbore friction as a function of flow rate and FIG. 8B shows the reflection coefficient for a tube wave carrying a rate drop ΔQ=10 bbl/min as a function of initial flow rate. The reflection coefficient labeled “perf+NWB” is calculated by solving equation (21) and the reflection coefficient labeled “linearized” is calculated using equation (13). Also shown is the reflection coefficient (labeled “perf only”) calculated from equation (21) when neglecting near-wellbore friction. FIG. 8C shows error in reflection coefficient when neglecting near-wellbore friction, obtained as the difference between the “perf only” reflection coefficient and the “perf+NWB” reflection coefficient.

As may be observed in FIGS. 8A through 8C, the tube wave reflection characteristics are affected primarily by the perforations at sufficiently high flow rate, with negligible contributions from the near-wellbore region. Dunham et al. (2023) analyzed water hammer generated by rate drops during the shut-in process, assuming that perforation friction controlled the tube wave reflection. The background rate was sufficiently high to justify neglecting near-wellbore friction.

### Improved Calculations of Perforation Cluster Efficiency Using an Erosion Model

The perforation friction factor depends on fluid density ρ, the number of perforation holes in the stage N, and the perforation hole diameter d:

$${k}_{perf} = \frac{8}{{π}^{2}} \frac{ρ}{{C}^{2} {N}^{2} {d}^{4}} , \qquad ( 24 )$$

where C is the dimensionless discharge coefficient that quantifies effects of flow contraction or expansion through the perforation. Typical values of discharge coefficient range from 0.6 to 0.95 (e.g., Cramer, 1987; Crump & Conway, 1988). A measurement of k_{perf} using the method described in Dunham et al. (2023) or its variation described below can be used to provide an estimate of the number of open perforations in a stage. This is termed the perforation cluster efficiency, defined as:

$$ε = \sqrt{{k}_{perf , design} / {k}_{perf , measured}} , \qquad ( 25 )$$

where the “design” value is evaluated from equation (24) using the number of perforations and perforation diameter in the well completion design and the “measured” value is obtained with acoustic friction analysis. Provided that the values ρ, C, and d used when calculating the design are representative of the actual values, then ε≈N_{actual}/N_{design}, the ratio of the actual number of perforations to the design number.

However, it is well known that erosion from the turbulent flow of fluids and proppant through the perforations increases the perforation hole diameter d. The discharge coefficient is also thought to increase, but this effect is generally much smaller than the changes in diameter. Thus, an accurate calculation of perforation cluster efficiency requires use of an erosion model. There are several available in the literature, such as Cramer (1987), which has been validated against downhole pressure gauge data and ultrasonic measurements of perforation diameter (Cramer et al., 2023). These models provide expressions for d and C as a function of total injected proppant. An erosion model similar to Cramer (1987) is used in the examples below.

### Measurements During Stimulation (Fracture Treatment)

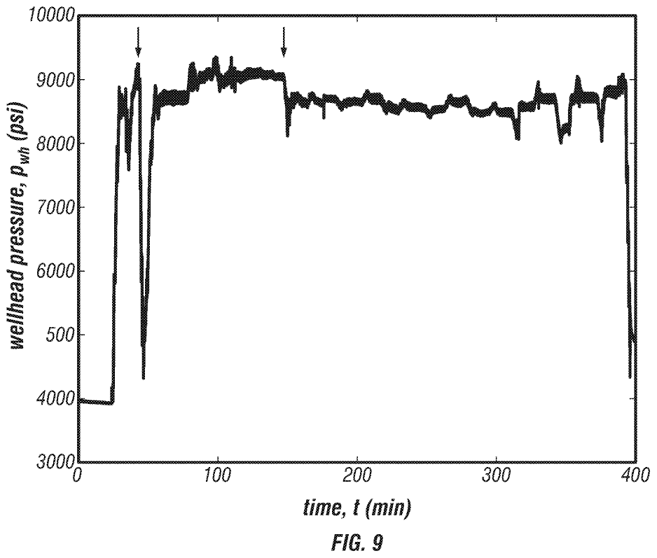

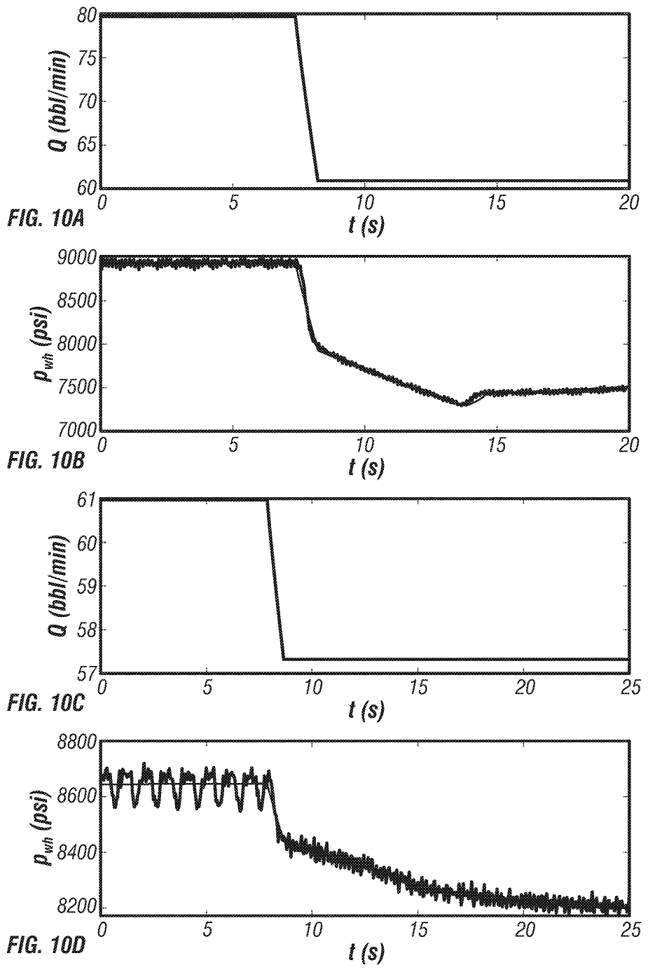

Acoustic friction analysis can be performed during stimulation, using fluid injection rate drops that occur, e.g., when one or more pumps are temporarily slowed or stopped. By performing the present method at different times during stimulation, the evolution of pipe and perforation friction and perforation cluster efficiency can be monitored. This monitoring can be used to measure changes in pipe friction as the composition of the injected fluid is altered, for example, by adjusting the concentration of friction reducer. It can also be used to monitor perforation cluster efficiency and to detect screen-out when proppant clogs one or more perforation clusters. FIGS. 9 and 10A through 10D illustrate an example of the foregoing method.

FIG. 9 shows a graph of wellhead pressure during stimulation of one fracture treatment stage. The two times that are marked with arrows correspond to rate drops that generated water hammer with the features required for acoustic friction analysis. FIGS. 10A through 10D show an enlarged view of the water hammers from two rate drops during stimulation, as marked by arrows in FIG. 9. Acoustic friction analysis provides a value of k_{perf}, which is used together with a perforation erosion model to calculate the perforation cluster efficiency. The efficiency is close to 100% for the first water hammer, near the start of the stimulation, but decreases to approximately 50% by the time of the second water hammer. This indicates that half of the clusters likely “screened out” part way through stimulation.

### Determining Both Perforation Friction and Near-Wellbore Friction

There may be times when the injection rate is too low to justify neglecting the near-wellbore impedance when analyzing the reflected tube wave. This commonly occurs during step down tests, in which injection rate is decreased through a set of rate drops (as shown in FIG. 2), or during shut-in when injection rate is dropped to zero. Under conditions where the stage impedance has appreciable contributions from both perforation and near-wellbore friction, analysis of water hammer from a single rate drop is insufficient to uniquely determine perforation and near-wellbore friction. However, separating perforation and near-wellbore contributions can be performed by analyzing multiple water hammers at different initial fluid flow (injection) rates.

First, consider multiple water hammers, each starting from a different initial fluid flow (injection) rate. The injection rate for measurement i is denoted as Qᵢ. Assume that these are of sufficiently small amplitude to justify use of equation (13) to determine the reflection coefficient. For each water hammer, the hydraulic impedance of the stage at the background rate, Zₛ(Qᵢ), may be determined by measuring the amplitude of the tube wave reflection or by numerical solution of the tube wave equations (5) and (6) with an impedance boundary condition for the stage described by the expression:

$$p ( L , T ) - p ( L , 0 ) = {Z}_{s} ( {Q}_{i} ) \times ( Q ( L , T ) - {Q}_{i} ) , \qquad ( 26 )$$

instead of the boundary condition given by equation (10). Next, a regression problem for the unknowns k_{perf}, k_{NWB}, and ξ is formulated using equations (14)-(16) for the stage impedance. The residual for each measurement is defined as:

$${r}_{i} = 2 {k}_{perf} {Q}_{i} + ζ {k}_{NWB} {Q}_{i}^{ξ - 1} - {Z}_{s} ( {Q}_{i} ) , \qquad ( 27 )$$

and the regression problem is to determine the unknowns by minimizing some norm of the residual. For example, a nonlinear least squares problem may be obtained using the L₂ norm

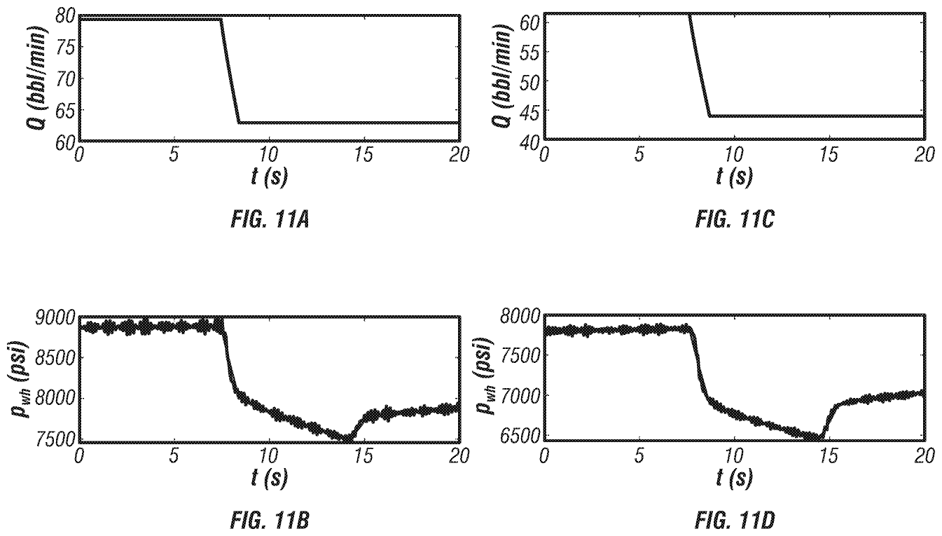

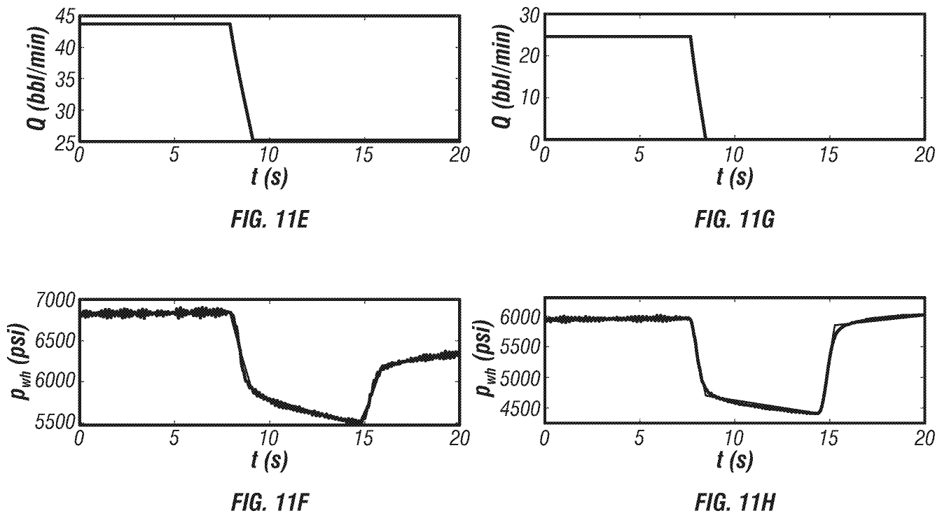

FIGS. 11A through 11H show graphs of four water hammers from the same stage but starting at different initial rates Qᵢ. The water hammer equations are solved for each stage and the stage impedance Zₛ(Qᵢ) is adjusted to best fit the data. Then values of k_{perf}, k_{NWB}, and ξ are determined by minimizing the misfit between the stage impedances and the sum of perforation impedance and near-wellbore impedance. For this example, the best-fitting values are k_{perf}=0.126 psi/(bbl/min)², k_{NWB}=25 psi/(bbl/min)^{0.6}, and ξ=0.6.

If the water hammer amplitude is not sufficiently small to warrant use of equation (13) for the reflection coefficient, then k_{perf}, k_{NWB}, and ξ can be determined by joint waveform inversion. The water hammer equations with bottom boundary condition (10) are solved for multiple water hammers, and a suitable misfit (e.g., L₂ norm of the difference between the numerical solution and the wellhead pressure data, summed over all water hammers) is minimized by adjusting k_{perf}, k_{NWB}, and ξ. This is similar to the previously described method, but the waveform inversion is performed simultaneously for all stages instead of for each stage separately. This method avoids the introduction of an impedance boundary condition and a separate regression step.

Alternatively, after correcting for attenuation by pipe friction, the reflection coefficient can be calculated by solving equation (21) for each water hammer. Then, a regression can be set up similarly to before but now using the nonlinear reflection coefficient equation (21) instead of the impedance equation (14).

### Slow Rate Drops (Changes)

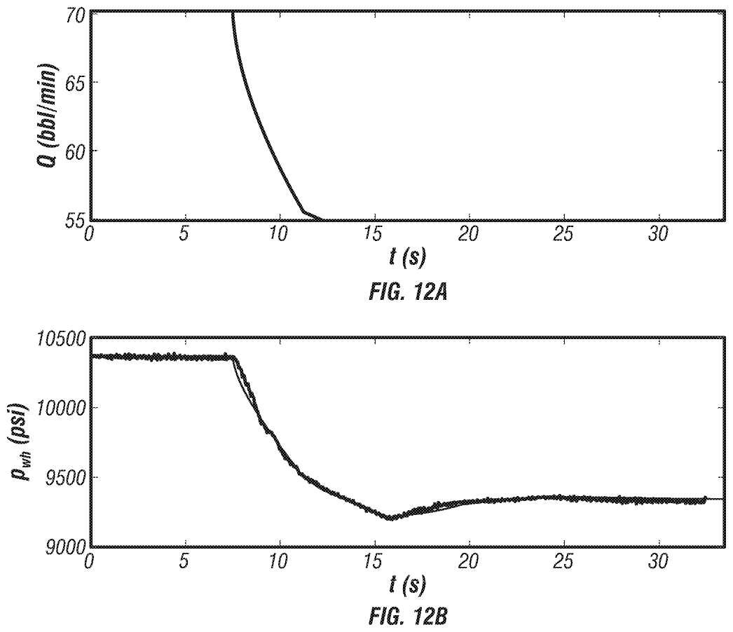

There are situations where the drop or change in fluid injection rate is too gradual to produce the waveform features shown in FIG. 3B. For example, the initial depressurization ramp caused by pipe friction may blur with the reflection caused by perforation and near-wellbore friction. Under high rate conditions, when near-wellbore friction is negligible, then the pressure response of the water hammer is controlled by the combined effects of pipe and perforation friction. Both are dependent on the square of flow rate, making it challenging or impossible to uniquely separate them. An example of such a situation is shown in FIGS. 12A and 12B.

### An Example Implementation of a Method According to the Disclosure

A method according to the present disclosure may comprise some or all of the following actions:
1. Pump fluid into a well at an initial (first) injection rate Q₀.
2. Change the injection rate (increase or decrease) to a second injection rate, Q₀−ΔQ, noting that the sign of ΔQ depends on whether the injection rate is increased or decreased. Injection rate may be changed, e.g., by changing speed of a fluid pump, closing or opening a valve, adding or removing a pump from the flow stream, or any combination of the foregoing. As explained earlier, the injection rate change should be of short enough duration to induce tube waves to propagate in the well.
3. Using a pressure sensor in fluid communication with the fluid in the well, e.g., a quartz pressure transducer, an optical fiber with Bragg grating or any other suitable pressure sensor, measure fluid pressure in the well. Well fluid pressure may change from p₀ to p₀−Δp₁, caused by the injection rate change. The fluid pressure may be determined by measuring pressure during pumping at the initial injection rate, followed by measuring pressure after the injection rate change. The pressure sensor may be disposed at any convenient position in the well, it being understood that proximate the surface end of the well, e.g., in or near the wellhead may be more convenient than other positions along the well. The pressure measurement after the rate change should be measured for a sufficient time in order to determine attributes of the pressure, specifically a slope of a gradual pressure drop after the rate change (feature [2] in FIG. 3B). As a practical matter, pressure may be measured until detection of a tube wave reflection from deeper features in the well, as noted below.
4. Determine the tube wave hydraulic impedance Z_{T}, e.g., using eq. (12) for the tube wave that results from the injection rate change. As equation (12) shows, determining Zr requires values for fluid density, tube wave speed, and cross-sectional area of the well. Fluid density may be determined by combining the known density of the liquid phase of the fluid (e.g., water) with the amount and density of proppant and/or other additives in the fluid being pumped into the well. Tube wave speed can be determined, e.g., from the tube wave two-way travel time to the end of the fracture treatment stage and back to the pressure sensor. The two-way travel time can be determined from the measured well fluid pressure data as the time at which the reflection arrives minus the time of the rate drop. The tube wave speed can also be determined from known expressions (see, e.g., Norris, 1990) including the density and compressibility of the fluid in the well (which are well known or may be readily determinable) and the compliance of the well (which depends on, among other parameters, the thickness of the well pipe or casing, the casing elastic moduli and the elastic moduli of the formation. The cross-sectional area of the well is known because it is part of the engineering design of the well.
5. Determine the change in rate ΔQ, e.g., by measuring it with a sensor such as a flow meter, determining a change in operating rate of a fluid pump or opening of a control valve, or by calculating it using the determined tube wave hydraulic impedance as ΔQ=Δp₁/Z_{T}.
6. Model the tube wave propagation from the time of the flow rate change until the detection time of the first reflection in the pressure measurements (as explained with reference to FIG. 3). Such model may be generated by solving equations (5)-(9) to obtain an expected set of well fluid pressures with respect to time based on the inputs to the above equations. The foregoing equations may be solved from the time of the flow rate change until the time of detecting the tube wave reflection, or longer as will be further explained below. The tube wave reflection arrives at a time that is 2L/c after the injection rate change. The measured depth to the fracture stage under evaluation in the well, L, is known from the engineering design of the well. Tube wave speed c can at least be estimated as explained with reference to determining the tube wave hydraulic impedance. For purposes of defining the scope of this part of the present method, it is not necessary to model the tube wave propagation all the way until the reflection. It is sufficient to model the tube wave propagation for some amount of time after the initial rate change in order to determine the slope of the depressurization feature [2] in the wellhead pressure measurements explained with reference to FIG. 3B. Using all of the pressure data between the flow rate change until the reflection arrival time, however, may enable obtaining a more accurate determination of the slope in the pressure data in feature [2].
7. The modeled well fluid pressure with respect to time, represented by p(0, t), is compared to the measured well fluid pressure with respect to time. The pipe friction factor f in the tube wave propagation model may be adjusted, the modeled pressures recalculated and the comparison to the measured well pressure may be repeated until the modeled fluid pressure in the well substantially matches the measured fluid pressure in the well.
8. Actions 1-7 may then be repeated for one or more different initial fluid injection rates, Qᵢ, each such different initial injection rate followed by a change in the injection rate from the different initial injection rate(s). Pressure measurements corresponding to the various initial injection rates and subsequent changed injection rates may be used to obtain a value of f corresponding to initial injection rate Q. The foregoing may comprise a set of data points (Qᵢ, fᵢ) corresponding to the values of initial injection rate and the associated friction factor f. As a non-limiting example, the graph in FIG. 2 represents well fluid pressure wherein a flow rate of fluid moving into the well is reduced four times successively, wherein the initial flow rate for each successive flow rate reduction corresponds to a distinct value of initial fluid injection rate followed by a flow rate decrease capable of inducing tube waves in the well.
9. A regression may be performed on the set of data points (Qᵢ, fᵢ) to determine parameters in a mathematical model (e.g., a deterministic expression or relationship) for f as a function of the initial injection rate Qᵢ. The relationship may be used in some implementations to determine an optimum value of initial injection (flow) rate.
10. In some implementations, using the pipe friction factors f determined as explained above, it is then possible to determine the pipe friction pressure loss per unit distance dpₚᵢₚₑ/dx for each value of initial injection rate Qᵢ. Perform a regression on the set of data points

$$( {Q}_{i} , \frac{{dp}_{pipe}}{{dx}_{i}} )$$

to determine parameters in a mathematical model (e.g., deterministic expression or relationship) for dpₚᵢₚₑ/dx as a function of initial injection flow rate Q. The friction pressure loss per unit distance dpₚᵢₚₑ/dx may be used, for example, to calculate or determine well fluid pressure at any position along the well during fluid pumping. In one example, well fluid pressure at perforations in the well pipe or casing may be determined.
11. In some implementations, actions 1-7 may be repeated for different fluid compositions. A regression may be performed for f or for dpₚᵢₚₑ/dx or a similar measure related to pipe friction, this time accounting for dependence on fluid composition in addition to the initial fluid flow rate. That is, one or more parameters related to the composition of the fluid being pumped (e.g., viscosity, proppant concentration, amount of friction reducer) may be adjusted and the actions repeated to obtain a relationship between the one or more composition parameters and the pipe friction parameter. The relationship may be used in some implementations to determine an optimum value of the composition parameter. For example and without limitation, the relationship may be used to determine a concentration of friction reducer that results in the lowest overall fluid pumping financial cost.
12. In some implementations, determine the tube wave speed c. In some implementations, the tube wave speed will have already been determined during the act of determining tube wave hydraulic impedance, explained above.
13. In some implementations, and using c determined above or obtained otherwise, model the tube wave propagation for additional time that includes the tube wave reflection from the well treatment stage under evaluation. The modeled tube wave propagation is compared to the measured pressure data from prior to the time of the injection rate change from the initial injection rate until after the detection of the reflected tube wave.
14. In some implementations, adjust the hydraulic impedance of the fracture treatment stage, Zₛ, or any other quantitative measure of the reflection condition at the fracture treatment stage, and repeat modeling the tube wave propagation and the comparison to the measured pressure until the modeled well fluid pressure most closely matches the measured well fluid pressure.
15. In some implementations, repeat actions 1-7 and 12-14 for different initial injection rates Q to obtain a set of data points (Q, Zₛ). The stage hydraulic impedance Zₛ can be replaced with any other quantitative measure of the reflection condition.
16. In some implementations, perform a regression of the (Q,Zₛ) data points to determine the perforation friction coefficient k_{perf}, the near-wellbore friction coefficient k_{NWB}, and the near-wellbore friction exponent ξ. The stage hydraulic impedance Zₛ can be replaced with any other quantitative measure of the reflection condition at the stage in this part of the method. The perforation friction coefficient k_{perf}, the near-wellbore friction coefficient k_{NWB}, and the near-wellbore friction exponent ξ may be used, for example to determine fluid pressure in any one or more fractures in the reservoir formation that are hydraulically connected to the well, e.g., by perforations in the well pipe or casing. As explained in the Background section herein, determining such pressure is important to the design and execution of hydraulic fracturing treatment.
17. In some implementations, an as-designed value of the perforation friction coefficient k_{perf} may be calculated or determined using the fluid density ρ, the number of perforations N in a stage, a zone or the well and the individual perforation diameter d. The perforation diameter d can be determined, e.g., by measurement, from the perforating charge manufacturer's published information or by using a perforation erosion model.
18. Using the determined value of perforation friction coefficient k_{perf} explained above, and the design value of k_{perf} explained above to calculate a value of perforation cluster efficiency ε. The perforation cluster efficiency may be used, for example, to determine when a perforated interval or zone in the well has become partially or totally obstructed, wherein the well operator may choose to reperforate the underperforming well interval. Perforation cluster efficiency may also indicate when the perforation diameter becomes excessively enlarged as a result of erosion. In another example use, the well operator might decide, upon determining a low perforation efficiency partway through a stimulation treatment, to stop pumping in order to prevent fractures from becoming longer than desired and to save costs on fluid and proppant and energy to the pumps.

In some implementations, values of f, (or dpₚᵢₚₑ/dx), k_{NWB}, k_{perf}, and ξ may be determined by the following:

Repeat actions 1-7 as explained above, wherein the pressure measurement continues until a reflected tube wave event is detected.

Model tube wave propagation during the reflection using selected initial values for of f, (or dpₚᵢₚₑ/dx), k_{NWB}, k_{perf}, and ξ using equation (10) for the bottom boundary condition. Equation (10) has a function defined in equation (11). Equation (11) has functions defined in equations (3) and (4). The modeled pressure response is then compared to the measured pressure response for all values of initial flow rate. That is, the comparison is made for the entire pressure measurement set as shown in FIG. 2.

Adjust the values of f, (or dpₚᵢₚₑ/dx), k_{NWB}, k_{perf} and ξ until the modeled pressure response matches the measured wellhead pressure for all of the different flow rates simultaneously. Because this uses data from multiple initial rates, the three parameters f, (or dpₚᵢₚₑ/dx), k_{NWB}, and k_{perf} can be uniquely determined.

In some implementations, once all the friction parameters f, (or dpₚᵢₚₑ/dx), k_{NWB}, k_{perf}, and ξ have been determined with respect to flow rate Q, it is then possible to estimate the fluid pressure in the subsurface reservoir formation based on measured fluid pressure (e.g., at the wellhead) and the flow rate. Such pressure may be used, for example, in predicting behavior of fracturing during a fracture treatment, or to determine an optimum fluid flow rate for pumping successive fracture treatment stages.

In some implementations, the perforation cluster efficiency may be used to estimate fractional amounts of the total amount of fluid being pumped into the well through a plurality of perforation clusters during pumping of a treatment, e.g., a hydraulic fracture treatment. For each stage or zone in a well undergoing treatment, a perforation friction coefficient k_{perf} may be determined as explained above, by detecting for each of a plurality of flow rate changes during pumping the treatment, a reflected tube wave event corresponding to each stage. The value of k_{perf} may be compared to the engineering design value of k_{perf} to obtain the stage perforation efficiency. Changes in the value of stage perforation efficiency may be determined over time during pumping of one or more stages by repeating determining k_{perf} during the treatment. Repeating determining the perforation friction coefficient may comprise making additional changes in flow rate later in the stage pumping and making pressure measurements as explained herein. Changes in calculated perforation efficiency may be used to allocate the total amount (volume) of fluid flow into the stage among a fraction of the total number of perforations or perforation clusters in the stage corresponding to the perforation efficiency calculated for the state with reference to the total number of perforations or clusters in the stage.

FIG. 12 shows an example of a rate drop that is too slow for acoustic friction analysis as explained above, as typically performed using a waveform inversion to match the waveform features shown in FIG. 3B, to uniquely separate pipe and perforation friction. This situation can be handled by using a calibrated model to determine pipe friction, leaving perforation friction as the remaining unknown in the acoustic friction waveform inversion.

In such circumstances, it is still possible to determine perforation friction from water hammer if there are independent constraints on pipe friction. One way to obtain such a constraint is to perform acoustic friction analysis to develop a calibrated model for pipe friction as a function of rate and fluid type (e.g., friction reducer type and concentration, proppant concentration) as explained earlier. A waveform inversion is performed as described in Dunham et al. (2023) or as shown previously. However, the calibrated model is used for pipe friction, leaving perforation friction as the remaining unknown (and if injection rate is sufficiently low, then near-wellbore friction is also an unknown). These unknowns become model parameters in the inversion, which are adjusted to best fit the water hammer data.

FIG. 13 shows an example computing system 1200 in accordance with some implementations. Actions described above with reference to example implementations may be carried out on a computer or computer system, wherein pressure measurements made as described may be entered into the computer or computer system and processed in the computer or computer system as explained above. The computing system 1200 may be an individual computer system 1201A or an arrangement of distributed computer systems. The individual computer system 1201A may include one or more analysis modules 1202 that may be configured to perform various tasks and controls according to some implementations, such as the tasks explained with reference to FIGS. 3-12. To perform these various tasks, the analysis module 1202 may operate independently or in coordination with one or more processors 1204, which may be connected to one or more storage media 1206. A display device (1205) such as a graphic user interface of any known type may be in signal communication with the processor 1204 to enable user entry of commands and/or data and to display results of execution of a set of instructions according to the present disclosure.

The processor(s) 1204 may also be connected to a network interface 1208 to allow the individual computer system 1201A to communicate over a data network 1210 with sensors, one or more additional individual computer systems and/or computing systems, such as 1201B, 1201C, and/or 1201D. Note that computer systems 1201B, 1201C and/or 1201D may or may not share the same architecture as computer system 1201A, and may be located in different physical locations, for example, computer systems 1201A and 1201B may be at a well drilling location, while in communication with one or more computer systems such as 1201C and/or 1201D that may be located in one or more data centers on shore, aboard ships, and/or located in varying countries on different continents.

A processor may include, without limitation, a microprocessor, microcontroller, processor module or subsystem, programmable integrated circuit, programmable gate array, or another control or computing device.

The storage media 1206 that captures data in a tangible medium may be implemented as one or more computer-readable or machine-readable storage media. Note that while in the example implementation of FIG. 13 the storage media 1206 are shown as being disposed within the individual computer system 1201A, in some implementations, the storage media 1206 may be distributed within and/or across multiple internal and/or external enclosures of the individual computing system 1201A and/or additional computing systems (e.g., 1201B, 1201C, 1201D), or over a network (“cloud”). Storage media 1206 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 1200 is only one example of a computing system, and that any other implementation of a computing system may have more or fewer components than shown, may combine additional components not shown in the example implementation of FIG. 13, and/or the computing system 1200 may have a different configuration or arrangement of the components are shown in FIG. 13. The various components are shown in FIG. 13. may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

A method according to the present disclosure may enable determining fluid friction pressure loss at any position along an entire well, in addition to determining fluid friction pressure loss through perforations in the well pipe or casing and near wellbore (in the formation proximate the well). The present method may comprise determining perforation efficiency, wherein perforations in a well pipe or casing adjacent to a fracture treatment stage may be evaluated, and if the well operator deems it necessary, to reperforate underperforming zones in the well.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

### REFERENCES CITED IN THIS DISCLOSURE

Chen, N. H. (1979). An explicit equation for friction factor in pipe. Industrial & Engineering Chemistry Fundamentals, 18 (3), 296-297.
Cramer, D. D. (1987). The application of limited-entry techniques in massive hydraulic fracturing treatments. Presented at the SPE Production Operations Symposium, Oklahoma City, Oklahoma, 8-10 March. SPE-16189-MS.
Cramer, D., Friehauf, K., Roberts, G., & Whittaker, J. (2019). Integrating DAS, treatment pressure analysis and video-based perforation imaging to evaluate limited entry treatment effectiveness. Presented at the SPE Hydraulic Fracturing Technology Conference and Exhibition, The Woodlands, Texas, USA, February 2019. SPE-194334-MS.
Cramer, D., White, M., & Douglas, C. (2023). Correlating Surface and Downhole Perforation Entry-Hole Measurements Lead to Development of Improved Perforating Systems. Paper presented at the SPE Hydraulic Fracturing Technology Conference and Exhibition, The Woodlands, Texas, USA, January 2023. SPE-212335-MS.
Crump, J. B., & Conway, M. W. (1988). Effects of perforation-entry friction on bottomhole treating analysis. Journal of Petroleum Technology, 40 (08), 1041-1048.
Dung, N., Cramer, D., Danielson, T., Snyder, J., Roussel, N., & Ouk, A. (2021). Practical applications of water hammer analysis from hydraulic fracturing treatments. Paper presented at the SPE Hydraulic Fracturing Technology Conference and Exhibition, Virtual, May 2021. SPE-204154-MS.
Dunham, E. M., Zhang, J., & Moos, D. (2023). Constraints on Pipe Friction and Perforation Cluster Efficiency from Water Hammer Analysis. Presented at the SPE Hydraulic Fracturing Technology Conference and Exhibition, The Woodlands, Texas, USA, February 2023. SPE-212337-MS.
Economides, M., Oligney, R., & Valkó, P. (2002). Unified fracture design: Bridging the gap between theory and practice. Orsa Press.
Keck, R. G., Nehmer, W. L., & Strumolo, G. S. (1992). A new method for predicting friction pressures and rheology of proppant-laden fracturing fluids. SPE Production Engineering, 7 (01), 21-28.
Lord, D. L., & McGowen, J. M. (1986). Real-time treating pressure analysis aided by new correlation. Paper presented at the SPE Annual Technical Conference and Exhibition, New Orleans, Louisiana, October 1986. SPE-15367-MS
Mondal, S., Zhang, M., Huckabee, P., Ugueto, G., Jones, R., Vitthal, S., Nasse, D., & Sharma, M. (2021). Advancements in step down tests to guide perforation cluster design and limited entry pressure intensities-Learnings from field tests in multiple basins. SPE Hydraulic Fracturing Technology Conference and Exhibition. SPE-204147-MS.
Moody, L. F. (1944). Friction factors for pipe flow. Trans. ASME, 66, 671-684.
Paillet, F. L., & White, J. E. (1982). Acoustic modes of propagation in the borehole and their relationship to rock properties. Geophysics, 47 (8), 1215-1228.
Ugueto C, G. A., Huckabee, P. T., Molenaar, M. M., Wyker, B., & Somanchi, K. (2016). Perforation cluster efficiency of cemented plug and perf limited entry completions; Insights from fiber optics diagnostics. SPE Hydraulic Fracturing Technology Conference. SPE-179124-MS.
Virk, P. S. (1975). Drag reduction fundamentals. AIChE Journal, 21 (4), 625-656.
Wang, X., Hovem, K., Moos, D., & Quan, Y. (2008). Water hammer effects on water injection well performance and longevity. Paper presented at the SPE International Symposium and Exhibition on Formation Damage Control, Lafayette, Louisiana, USA, February 2008. SPE-112282-MS.
Wylie, E. B., Streeter, V. L., & Suo, L. (1993). Fluid transients in systems. Englewood Cliffs, NJ: Prentice Hall.
Yang, B., Zhao, J., Mao, J., Tan, H., Zhang, Y., & Song, Z. (2019). Review of friction reducers used in slickwater fracturing fluids for shale gas reservoirs. Journal of Natural Gas Science and Engineering, 62, 302-313.

What is claimed is:

1. A method for determining fluid friction pressure losses in a well into which fluid is being pumped, comprising:
a. measuring fluid pressure in the well while pumping the fluid at a first flow rate;
b. changing the first flow rate to a second flow rate different than the first flow rate and measuring the fluid pressure after the changing for a selected time;
c. modeling a pressure response of the well using a selected value of a parameter related to pipe friction factor f,
d. comparing the modeled pressure response to the measured pressure;
e. adjusting the value of the parameter related to f and repeating the modeling and comparing until the modeled pressure response substantially matches the measured pressure;
f. changing the first flow rate and repeating (a) through (e), and determining a relationship between the value of f and the first flow rate.

2. The method of claim 1, further comprising:
g. continuing measuring pressure until a reflected tube wave event is detected;
h. modeling a pressure response of the well using a selected value of a parameter related to reflection coefficient for at least the first flow rate;
i. adjusting the parameter related to reflection coefficient and repeating the modeling the pressure response for the first flow rate and the second flow rate until the modeled pressure response substantially matches the measured pressure;
j. changing the first flow rate and repeating (h) and (i) to determine a relationship between the first flow rate and the parameter related to reflection coefficient; and
k. using the relationship between the parameter related to f and the first flow rate, and the relationship between the parameter related to reflection coefficient and the first flow rate to estimate values of frictional pressure loss through well perforations and frictional pressure loss in a near wellbore region.

3. The method of claim 2 further comprising determining a design friction pressure loss for the well perforations and using the estimated frictional pressure loss through the well perforations to obtain a value of perforation cluster efficiency.

4. The method of claim 3 further comprising using the perforation cluster efficiency to allocate fluid flow volume to a corresponding fraction of a total number of perforation clusters.

5. The method of claim 4 further comprising repeating obtaining a value of perforation cluster efficiency and allocation fluid flow volume at selected times during pumping a treatment into the well.

6. The method of claim 2 wherein the parameter related to reflection coefficient comprises hydraulic impedance of a fracture stage in the well.

7. The method of claim 1, further comprising:
changing at least one composition parameter of the fluid being pumped into the well; and
repeating (a) through (f) to determine a relationship between the at least one composition parameter and the relationship between f and the first flow rate.

8. The method of claim 7 further comprising using the relationship between the at least one composition parameter and the relationship between the parameter related to f and the first flow rate to determine an optimum value of the at least one composition parameter.

9. The method of claim 1 further comprising using the relationship between the value of the parameter related to f and the first flow rate to determine an optimum value of the first flow rate.

10. A method for determining fluid friction pressure losses in a well into which fluid is being pumped, comprising:
a. measuring fluid pressure in the well while pumping the fluid at a first flow rate;
b. changing the first flow rate to a second flow rate different than the first flow rate and measuring the fluid pressure after the changing for a selected time;
c. modeling a pressure response of the well using a selected value of a parameter related to pipe friction factor f,
d. comparing the modeled pressure response to the measured pressure;
e. adjusting a value of the parameter related to f and repeating the modeling and comparing until the modeled pressure response substantially matches the measured pressure;
f. changing at least one composition parameter of the fluid being pumped and repeating (a) through (e), and determining a relationship between the value of the parameter related to f and the at least one composition parameter.

11. The method of claim 10 further comprising using the relationship to determine an optimum value of the at least one composition parameter.

12. The method of claim 10, further comprising:
g. continuing measuring pressure until a reflected tube wave event is detected;
h. modeling a pressure response of the well using a selected value of a parameter related to reflection coefficient for at least the first flow rate;
i. adjusting the value of the parameter related to reflection coefficient and repeating the modeling the pressure response for the first flow rate and the second flow rate until the modeled pressure response substantially matches the measured pressure;
j. changing the first flow rate and repeating (h) and (i) to determine a relationship between the first flow rate and the parameter related to reflection coefficient and
k. using the relationship between the parameter related to f and the first flow rate, and the relationship between the parameter related to reflection coefficient and the first flow rate to estimate values of frictional pressure loss through well perforations and frictional pressure loss in a near wellbore region.

13. The method of claim 12 further comprising determining a design friction pressure loss for the well perforations and using the estimated frictional pressure loss through the well perforations to obtain a value of perforation cluster efficiency.

14. The method of claim 12 wherein the parameter related to reflection coefficient comprises hydraulic impedance of a fracture treatment stage in the well.

15. A method for determining fluid friction pressure losses in a well into which fluid is being pumped, comprising:
a. measuring fluid pressure in the well while pumping the fluid at a first flow rate;
b. changing the first flow rate to a second flow rate different than the first flow rate and measuring the fluid pressure after the changing from the first flow rate to the second flow rate at least until a first reflected tube wave event is detected in the measured pressure;
c. changing the second flow rate to a third flow rate different from the first flow rate and the second flow rate and measuring the fluid pressure after the changing from the second flow rate to the third flow rate until a second reflected tube wave event is detected in the measured pressure;
d. modeling fluid pressure in the well using selected initial values for frictional pressure loss in the well, frictional pressure loss in well pipe perforations and frictional pressure loss in a near wellbore zone in a reservoir formation;
e. comparing the measured pressure to the modeled fluid pressure and adjusting the initial values of the frictional pressure loss in the well, frictional pressure loss in well pipe perforations and frictional pressure loss in the near wellbore zone and repeating modeling the fluid pressure in the well; and
f. repeating (e) until the modeled fluid pressure in the well matches the measured pressure in the well for all of the first flow rate, the second flow rate and the third flow rate.

16. The method of claim 15 further comprising determining a design friction pressure loss for the well perforations and using the estimated frictional pressure loss through the well perforations to obtain a value of perforation cluster efficiency.

17. The method of claim 15 further comprising changing at least one composition parameter of the fluid, and repeating (a) through (f) to determine a relationship between the at least one composition parameter and the frictional pressure loss in the well, frictional pressure loss in well pipe perforations and frictional pressure loss in the near wellbore zone.

18. A non-transitory computer readable medium having stored thereon instructions operable to cause a programmable computer to perform a process for determining fluid friction pressure losses in a well into which fluid is being pumped, the process comprising actions comprising:
a. causing the computer to accept as input measurements of fluid pressure in the well made while pumping the fluid at a first flow rate;
b. causing the computer to accept as input measurements of fluid pressure in the well after changing the first flow rate to a second flow rate different than the first flow rate and made at least until a change in pressure for a selected time;
c. in the computer, modeling a pressure response of the well using a selected value of a parameter related to pipe friction factor f,
d. in the computer, comparing the modeled pressure response to the measured pressure;
e. in the computer, adjusting a value of the parameter related to f and repeating the modeling and comparing until the modeled pressure response substantially matches the measured pressure;
f. accepting as input to the computer measurements of pressure made after changing the first flow rate, and in the computer repeating (a) through (e), and determining a relationship between the value of the parameter related to f and the first flow rate.

19. The non-transitory computer readable medium of claim 18, further comprising logic operable to cause the computer to perform acts comprising:
g. accepting as input to the computer measurements of fluid pressure in the well made until a reflected tube wave event is detected;
h. in the computer, modeling a pressure response of the well using a selected value of a parameter related to reflection coefficient for at least the first flow rate;
i. in the computer, adjusting the value of the parameter related to reflection coefficient and repeating the modeling the pressure response for the first flow rate and the second flow rate until the modeled pressure response substantially matches the measured pressure;
j. in the computer, changing the first flow rate and repeating (h) and (i) to determine a relationship between the first flow rate and the parameter related to reflection coefficient; and
k. in the computer, using the relationship between the parameter related to f and the first flow rate, and the relationship between the parameter related to reflection coefficient and the first flow rate to estimate values of frictional pressure loss through well perforations and frictional pressure loss in a near wellbore region.

20. The non-transitory computer readable medium of claim 19, further comprising logic operable to cause the computer to perform acts comprising determining a design friction pressure loss for the well perforations and using the estimated frictional pressure loss through the well perforations to obtain a value of perforation cluster efficiency.

21. The non-transitory computer readable medium of claim 20, further comprising logic operable to cause the computer to perform acts comprising using the perforation cluster efficiency to allocate fluid flow volume to a corresponding fraction of a total number of perforation clusters.

22. The non-transitory computer readable medium of claim 21, further comprising logic operable to cause the computer to perform acts comprising repeating obtaining a value of perforation cluster efficiency and allocation fluid flow volume at selected times during pumping a treatment into the well.

23. The non-transitory computer readable medium of claim 19 wherein the parameter related to reflection coefficient comprises hydraulic impedance of a fracture treatment stage in the well.

24. The non-transitory computer readable medium of claim 18, further comprising logic operable to cause the computer to perform acts comprising:
after a change in at least one composition parameter of the fluid being pumped into the well; and
repeating (a) through (f) to determine a relationship between the at least one composition parameter and the relationship between the parameter related to f and the first flow rate.

25. The non-transitory computer readable medium of claim 18, further comprising logic operable to cause the computer to perform acts comprising in the computer, using the relationship between the at least one composition parameter and the relationship between the parameter related to f and the first flow rate to determine an optimum value of the at least one composition parameter.

26. The non-transitory computer readable medium of claim 18, further comprising logic operable to cause the computer to perform acts comprising in the computer, using the relationship between the value of the parameter related to f and the first flow rate to determine an optimum value of the first flow rate.

27. A non-transitory computer readable medium having stored thereon instructions operable to cause a programmable computer to perform a process for determining fluid friction pressure losses in a well into which fluid is being pumped, the process comprising actions comprising:
a. accepting as input to the computer, measurements of fluid pressure in the well made while pumping the fluid at a first flow rate;
b. accepting as input to the computer measurements of fluid pressure in the well after changing the first flow rate to a second flow rate different than the first flow rate made for a selected time;
c. in the computer, modeling a pressure response of the well using a selected value of a parameter related to pipe friction factor f,
d. in the computer, comparing the modeled pressure response to the measured pressure;
e. in the computer, adjusting the value of the parameter related to f and repeating the modeling and comparing until the modeled pressure response substantially matches the measured pressure;
f. in the computer, changing at least one composition parameter of the fluid being pumped and repeating (a) through (e), and determining a relationship between the value of the parameter related to f and the at least one composition parameter.

28. The non-transitory computer readable medium of claim 27, further comprising logic operable to cause the computer to perform acts comprising using the relationship to determine an optimum value of the at least one composition parameter.

29. The non-transitory computer readable medium of claim 27, further comprising logic operable to cause the computer to perform acts comprising:
g. accepting as input to the computer measurements of fluid pressure in the well made until a reflected tube wave event is detected;
h. in the computer, modeling a pressure response of the well using a selected value of a parameter related to reflection coefficient for at least the first flow rate;
i. in the computer, adjusting the value of the parameter related to reflection coefficient and repeating the modeling the pressure response for the first flow rate and the second flow rate until the modeled pressure response substantially matches the measured pressure;
j. in the computer, changing the first flow rate and repeating (h) and (i) to determine a relationship between the first flow rate and the parameter related to reflection coefficient; and
k. in the computer, using the relationship between the parameter related to f and the first flow rate, and the relationship between the parameter related to reflection coefficient and the first flow rate to estimate values of frictional pressure loss through well perforations and frictional pressure loss in a near wellbore region.

30. The non-transitory computer readable medium of claim 27 wherein the parameter related to reflection coefficient comprises hydraulic impedance of a fracture treatment stage in a well.

31. The non-transitory computer readable medium of claim 27 further comprising logic operable to cause the computer to perform acts comprising in the computer, determining a design friction pressure loss for the well perforations and using the estimated frictional pressure loss through the well perforations to obtain a value of perforation cluster efficiency.

32. A non-transitory computer readable medium having stored thereon instructions operable to cause a programmable computer to perform a process for determining fluid friction pressure losses in a well into which fluid is being pumped, the process comprising actions comprising:
a. accepting as input to the computer, measurements of fluid pressure in the well made while pumping the fluid at a first flow rate;
b. accepting as input to the computer, measurements of fluid pressure in the well made after changing the first flow rate to a second flow rate different than the first flow rate at least until a first reflected tube wave event is detected in the measured pressure;
c. accepting as input to the computer measurements of fluid pressure in the well made after changing the second flow rate to a third flow rate different from the first flow rate until a second reflected tube wave event is detected in the measured pressure;
d. in the computer, modeling fluid pressure in the well using selected initial values for frictional pressure loss in the well, frictional pressure loss in well pipe perforations and frictional pressure loss in a near wellbore zone in a reservoir formation;
e. in the computer, comparing the measured pressure to the modeled fluid pressure and adjusting the initial values of the frictional pressure loss in the well, frictional pressure loss in well pipe perforations and frictional pressure loss in the near wellbore zone and repeating modeling the fluid pressure in the well; and
f. repeating (e) until the modeled fluid pressure in the well matches the measured pressure in the well for all of the first flow rate, the second flow rate and the third flow rate.

33. The non-transitory computer readable medium of claim 32, further comprising logic operable to cause the computer to perform acts comprising in the computer, determining a design friction pressure loss for the well perforations and using the estimated frictional pressure loss through the well perforations to obtain a value of perforation cluster efficiency.

34. The non-transitory computer readable medium of claim 32, further comprising logic operable to cause the computer to perform acts comprising, after changing at least one composition parameter of the fluid, repeating (a) through (f) to determine a relationship between the at least once composition parameter and the frictional pressure loss in the well, frictional pressure loss in well pipe perforations and frictional pressure loss in the near wellbore zone.
